(19) United States
(12) Patent Application Publication
(10) Pub. No.: US 2012/0100979 A1
(43) Pub. Date: Apr. 26, 2012

(54) CENTRIFUGE BUCKET RESTRAINING APPARATUS AND METHODS OF USE OF SAME

(75) Inventor: Dennis Chin, Island Park, NY (US)

(73) Assignee: NEW YORK BLOOD CENTER, INC., New York, NY (US)

(21) Appl. No.: 12/912,530

(22) Filed: Oct. 26, 2010

(51) Int. Cl. B04B 7/06; B01D 21/26

(52) U.S. Cl. 494/12; 494/37

(57) ABSTRACT

Described herein are retention systems comprising an elastic member coupled to at least one securing member, a centrifuge bucket, and at least one item in the centrifuge bucket. The elastic member is attachable to at least two points on said centrifuge bucket thereby retaining the at least one item within the centrifuge bucket. Methods of using these systems are also described.

### FIELD OF THE INVENTION

Presently described are systems used to retain items within a centrifuge bucket. The items within the centrifuge bucket can be hazardous material the release of which contaminates a centrifuge system.

### BACKGROUND

Commonly, the banking of blood requires testing before its addition to a central store of blood. Whether blood is being added to a bank or is simply being assayed, centrifuging whole blood is commonplace at facilities storing or processing blood.

Despite everyday centrifugation of blood, one small mistake, such as miss calculation of counter balance or improper securing of a blood sample within the centrifuge bucket or rotor, causes rupture and displacement of blood or separated blood components throughout the centrifuge apparatus. Such a displacement requires vast amounts of time and money to disassemble the apparatus and subsequently disinfect and clean each contaminated part.

To date, keeping contents within a centrifuge bucket during operation has relied on the inherent gravity supplied by the centripetal acceleration of the rotor as it is spun inside the centrifuge. However, unless the contents of the bucket are symmetrical or perfectly balanced, movement of the contents is inevitable. As such, even without mistakes, displacement and system wide contamination is a growing concern.

Even when hazardous materials are being transferred around a laboratory space either in preparation for centrifugation, subsequent to centrifugation, or just for transport proposes, it is important to keep the items within the centrifuge bucket intact and to prevent rupture. For example, items dangling out of the centrifuge bucket can get caught and tear, burst, or be punctured by collateral objects. As such, there exists vital need to keep the hazardous contents of the centrifuge bucket retained even when outside of the centrifuge machine.

A means for properly securing the items within a centrifuge bucket are needed in the art. The present disclosure provides a means to fill this long felt need in the art.

### SUMMARY

Described herein are retention systems comprising an elastic member coupled to at least one securing member, a centrifuge bucket, and at least one item in the centrifuge bucket. The elastic member is attachable to at least two points on said centrifuge bucket thereby retaining the at least one item within the centrifuge bucket.

In one embodiment, the at least one securing member is a hook. The systems, for example, can have two hooks. The hooks can be attached to the elastic member, which can be continuous. The elastic member in some embodiments is about 0.5 inches wide and about 3.5 inches long in a relaxed state.

In another embodiment, a centrifuge bucket comprises a lip having two convex protrusions on opposite sides of the lip. For example, the at least two points wherein the elastic member is attached to the centrifuge bucket are the two convex protrusions. In still another embodiment, the at least two points wherein the elastic member is attached to the centrifuge bucket further include two additional points on the lip.

In one embodiment, the at least one item in the centrifuge bucket is blood in test tubes, bags, polymer tubes, and combinations thereof. The bucket can further comprise a blood filter.

Further described herein are uses for the retention systems described. For example, the retention systems can be used in a centrifuge instrument at a speed sufficient to separate blood components. In some embodiments, that speed is less than about 3,000 rpm. In other embodiments, the retention systems prevent the at least one item from dislodging from the centrifuge bucket during a centrifugation.

Even further still, described herein is a retention system comprising an elastic member about 0.5 inches wide and about 3.5 inches long in a relaxed state coupled to two hooks, a centrifuge bucket comprising a lip having two convex protrusions on opposite sides of the lip; and at least one blood storage component in the centrifuge bucket. The elastic member therein is attachable to the two convex protrusions on the centrifuge bucket thereby retaining the at least one blood storage component within the centrifuge bucket.

In one embodiment, methods are described for preventing contamination in a centrifuge system comprising: providing a centrifuge bucket and at least one item to be placed within the centrifuge bucket for centrifugation; placing the at least one item within the centrifuge bucket; retaining the at least one item within the centrifuge bucket using at least one elastic member coupled to at least one securing member; centrifuging the at least one item within the centrifuge bucket; prohibiting rupture or dislocation of the at least one item; and preventing contamination in a centrifuge system.

For example, described are methods of preventing contamination of a centrifuge system by hazardous material comprising: providing a centrifuge bucket and blood bag system including a filter to be placed within the centrifuge bucket for centrifugation; placing the blood bag system including a filter within the centrifuge bucket; retaining blood bag system including a filter within the centrifuge bucket using an elastic member coupled to at least two hooks coupled to the lid of the centrifuge bucket; centrifuging blood contained within the blood bag system; prohibiting rupture or dislocation blood from the blood bag system; and preventing contamination of the centrifuge system by hazardous material.

### BRIEF DESCRIPTION OF THE DRAWINGS

FIGS. 1A and 1B illustrate an elastic member and accompanying securing members according to an example embodiment described herein.

FIGS. 2A, 2B and 2C illustrate an exemplary centrifuge bucket.

FIG. 3 illustrates an exemplary blood bag system.

FIG. 4 illustrates a rack of loaded centrifuge buckets after being centrifuged without the retention systems described herein.

FIG. 5 illustrates an exemplary process of applying the retention systems described herein according to an example embodiment described herein.

FIG. 6 illustrates a centrifuge rotor loaded with centrifuge buckets having items held in place by the retention systems described herein according to an example embodiment described herein.

FIG. 7 illustrates a rack of loaded centrifuge buckets after being centrifuged with the retention systems described herein according to an example embodiment described herein.

FIG. 8 illustrates another exemplary elastic member and accompanying securing members according to an example embodiment described herein.

FIG. 9 illustrates an exemplary set of elastic members and accompanying securing members according to an example embodiment described herein.

FIG. 10 illustrates another exemplary elastic member and accompanying securing members according to an example embodiment described herein.

### DETAILED DESCRIPTION

Described herein generally are retention systems to hold items within a centrifuge bucket both during centrifugation and for transport. The systems comprise an elastic member coupled to at least one securing member, a centrifuge bucket, and at least one item in the centrifuge bucket. In a broad aspect, the retention systems are used to hold at least one item within the centrifuge bucket during centrifugation. Retaining or holding items within the centrifuge bucket is particularly important wherein sensitive and/or hazardous materials are being processed.

To date, when processing sensitive materials such as blood or urine on a large scale, for example, greater than 500 mL bucket capacity, such items are retained within a centrifuge bucket by centripetal force exerted on the items during centrifugation. No other means of restraint have been employed. This is of growing concern because when parts or portions of the items becoming dislodged, leaking and contamination of the entire system is not uncommon, after which point, time and money are lost in cleaning and sanitizing the system.

The present retention systems, in part, prevent the occurrence of lost time and money resulting from rupturing and/or leaking samples by holding items securely within a centrifuge bucket both while at rest, during transport, and during the centrifugation process.

The elastic member can be made of any material that has elastic properties, that is, it will expand to a documented length without breaking in response to external pressure or force. Exemplary elastic members include, but are not limited to rubber bands, bungee cords, and the like. The elastic member can be a single strand of material or can be in the form of a loop, or multiple loops.

The size of the elastic member also varies depending on the application; for example, the type and size of the centrifuge bucket and/or the items placed within the centrifuge bucket determine the size of the elastic member needed to restrain the bucket's contents. For example, either as a strand or as a loop's longest axis, the length of the elastic member in the unexpanded, or relaxed state is from about 1 inch to about 5 inches, about 2 inches to about 4 inches, or about 2.5 inches to about 3.5 inches. In one example embodiment, the length of the elastic member is about 3.5 inches. The width of a single strand of elastic member in the unexpanded state is generally from about 0.0005 inch to about 2 inches, or about 0.1 inch to about 1 inch, or about 0.3 inch to about 0.75 inch. In one example embodiment, the elastic member has a width of about 0.5 inch in the unexpanded state.

Expanded states for the elastic members depend not only on the thickness, length and width of the member itself, but also the composition of the material used to form it. Many elastic members formed of rubber, in many cases synthetic rubber have specific sizes and industry standard expansion state characteristics. In one example embodiment, the elastic member is a #84 rubber band. In another example embodiment, the elastic member is a #73 rubber band.

Depending on the material used to form the elastic member, the dimensions described above can be varied greatly. One skilled in the art of rheological properties of elastic materials understands how to develop an elastic member of a stretched length depending on the materials used to form the elastic member in the relaxed state. For example, a thin elastic material can in some embodiments be used to cover the entire top of a centrifuge bucket.

The elastic member can be made from any expandible material, preferably a polymer, that expands to a documented length without breaking in response to external pressure or force. In one embodiment, the polymer chosen to form the elastic member can include polyurethanes, silicones, polyesters polyolefins, polyisobutylene and ethylene-alphaolefin copolymers, acrylic polymers and copolymers, ethylene-co-vinylacetate, polybutylmethacrylate, vinyl halide polymers and copolymers (e.g. polyvinyl chloride), polyvinyl ethers (e.g. polyvinyl methyl ether), polyvinylidene halides (e.g. polyvinylidene fluoride and polyvinylidene chloride), polyacrylonitrile, polyvinyl ketones, polyvinyl aromatics (e.g. polystyrene), polyvinyl esters (e.g. polyvinyl acetate), polyvinyl amides, copolymers of vinyl monomers with each other and olefins (e.g. ethylene-methyl methacrylate copolymers, acrylonitrile-styrene copolymers, ABS resins, and ethylene-vinyl acetate copolymers), polyamides (e.g. Nylon 66 and polycaprolactam), alkyd resins, polycarbonates, polyoxymethylenes, polyimides, polyethers, epoxy resins, polyurethanes, rayon rayon-triacetate, cellulose, cellulose acetate, cellulose butyrate, cellulose acetate butyrate, cellophane, cellulose nitrate, cellulose propionate, cellulose ethers, carboxymethyl cellulose, poly(L-lactic acid), polycaprolactone, poly(lactide-co-glycolide), poly(ethylene-vinyl acetate), poly(hydroxybutyrate-co-valerate), polydioxanone, polyorthoester, polyanhydride, poly(glycolic acid), poly(D,L-lactic acid), poly(glycolic acid-co-trimethylene carbonate), polyphosphoester, polyphosphoester urethane, poly(amino acids), cyanoacrylates, poly(trimethylene carbonate), poly(iminocarbonate), copoly(ether-esters) (e.g. PEO/PLA), polyalkylene oxalates, polyphosphazenes and biomolecules such as fibrin, fibrinogen, cellulose, starch, collagen, hyaluronic acid, and combinations thereof. In one example embodiment, the polymer is rubber, latex rubber and/or synthetic rubber.

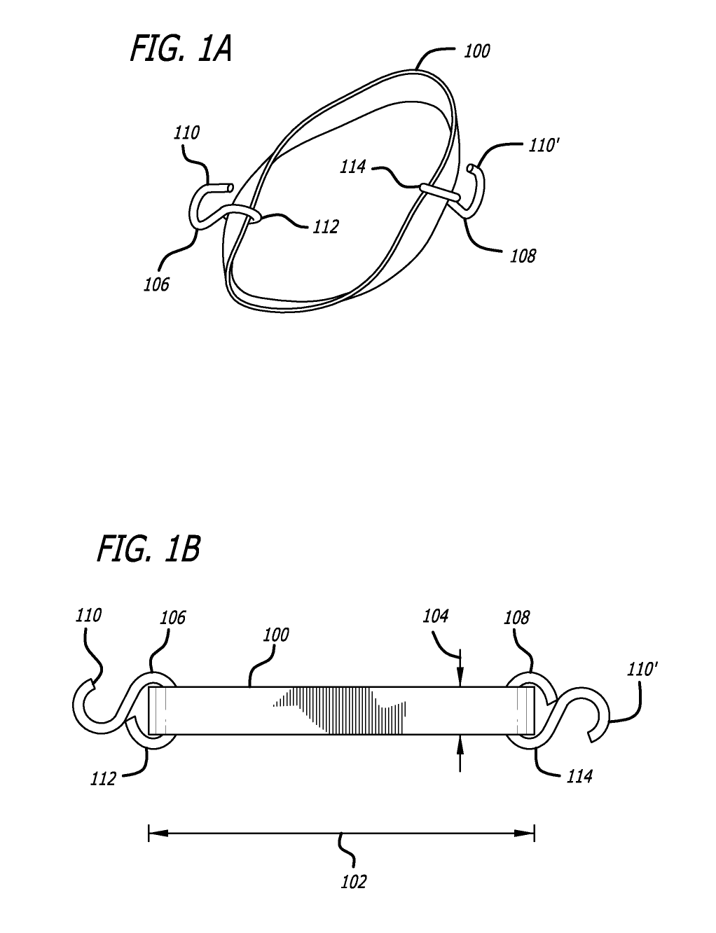

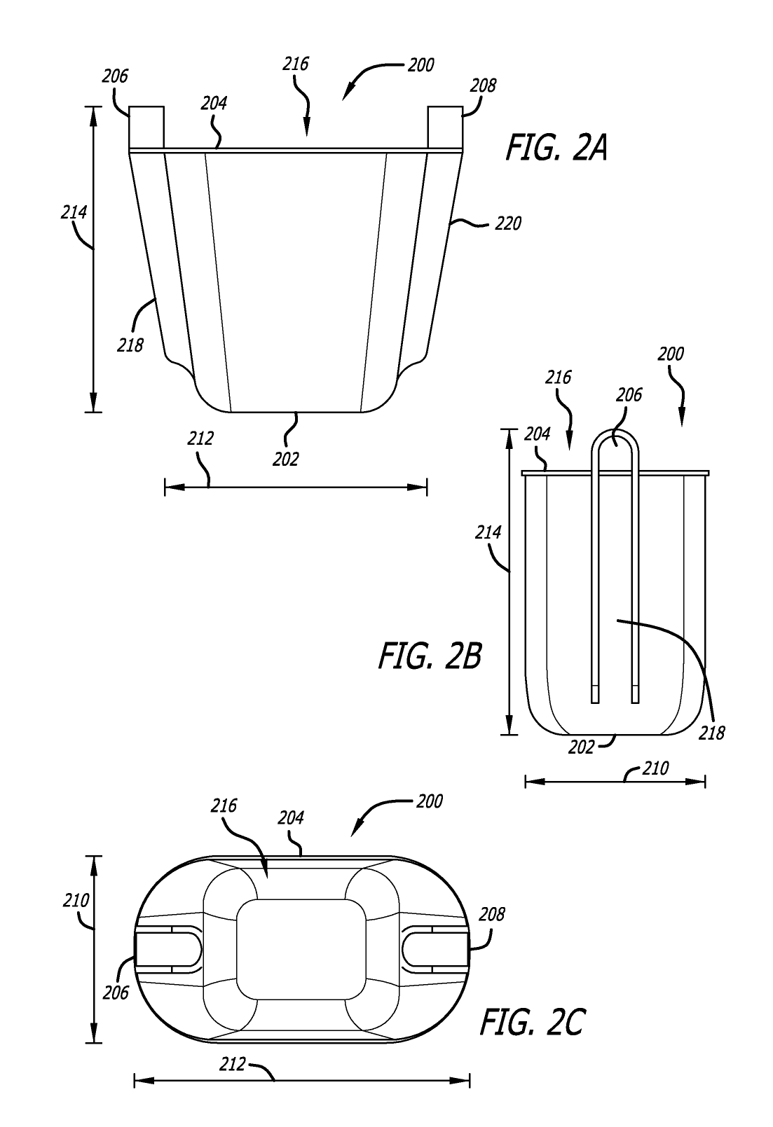

In one embodiment, illustrated in FIG. 1, elastic member 100 is illustrated. Elastic member 100 includes unexpanded length 102 and unexpanded width 104. In this particular embodiment, elastic member 100 includes or is coupled to first securing member 106 and second securing member 108. Both first securing member 106 and second securing member 108 include hooks 110, 110′ and are coupled to elastic member 100 with first loop 112 and second loop 114. First loop 112 and second loop 114 couple first securing member 106 and second securing member 108 to elastic member 100 so that elastic member 100 can be expanded with applied force without detaching first securing member 106 and second securing member 108 therefrom.

The at least one securing member can be in the form of a hook, a loop, a point, a clamp or a hook-and-loom connection, a glue pad, or a snap. Further, the securing member can be formed of an appropriate material such as, but not limited to, hard plastic, metal, soft polymer or the like. Metals such as, but not limited to, steel, zinc, aluminum, copper, titanium and combinations thereof can be useful.

In one example embodiment, as illustrated in FIG. 1, at least one securing member is a modified s-hook. S-hooks are generally formed zinc plated steel. In order to use an s-hook, the at least one elastic member is fitted through the bottom hook of and subsequently, the bottom hook can be bent to form an enclosed ring securing elastic member therein.

The retention systems described herein are particularly useful for lower speed centrifuges. “Low speed” centrifuges are industrially popular because larger volume and/or more delicate materials (e.g. cells, proteins and the like) can be subjected to centripetal force without the higher speed applied by many centrifuges. It is not uncommon for 1 L or larger samples to be loaded into an open cavity in a centrifuge rotor. Samples are generally loaded into a centrifuge bucket which is then loaded into the rotor. Low speed as defined herein is typically less than about 10,000 RPM, less than about 5,000 RPM, less than about 4,000 RPM, less than about 3,000 RPM, less than about 2,000 RPM, less than about 1,000 RPM, less than about 500 RPM, or less than about 100 RPM.

A centrifuge bucket comes in various shapes and sizes and can even be custom fabricated for a particular sample. Typically, however, centrifuge buckets range from about 5 mL to about 1 L in capacity.

In one illusory embodiment, an example centrifuge bucket holds about 500 mL to about 550 mL of capacity. Centrifuge bucket 200 includes bottom 202, rim or lip 204, first grasping means 206 and second grasping means 208. First grasping means 206 and second grasping means 208 are convex protrusions on opposite sides of said lip 204. These protrusions are generally where securing members attached to centrifuge bucket 200. In some embodiments, securing members can attached to any point around lip 204 as needed to secure an elastic member to the centrifuge bucket. Centrifuge bucket 200 has a depth 210, a width 212 and a height 214, all defining internal volume 216. Depth 210 can be about 4 inches, width 212 can be about 6.5 inches and height 214 can be about 6.25 inches. Centrifuge bucket 200 further includes first guide 218 and second guide 220 to aid in sliding centrifuge bucket 200 into a rotor (not illustrated). Centrifuge bucket can be formed of any stiff material such as metal or glass, but is preferably formed of a hard plastic.

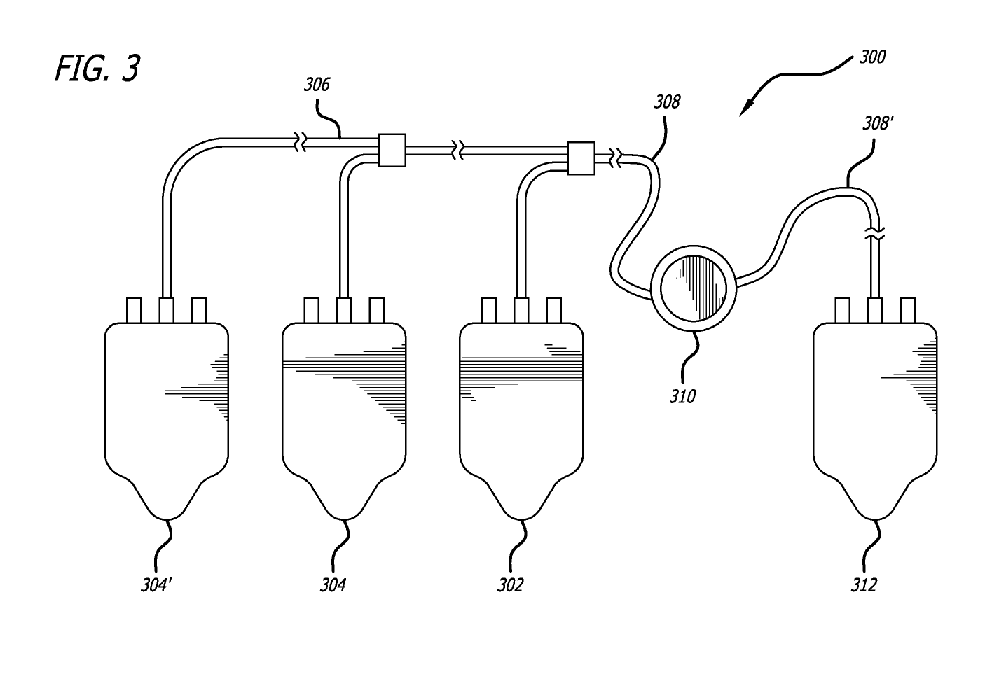

The contents or items placed within internal volume 216 of centrifuge bucket 200 can be any item or items which need to be subjected to centripetal force. In one embodiment, the at least one item is a blood product. For example, the at least one item can be a set of blood donation and separation bags, termed here as bag system 300 as illustrated in FIG. 3. In such a system, donation bag 302 is used to collect blood from a donor. After collection, sophisticated equipment such as pumps, computerized assay equipment, and the like can be used to move blood products between one or more additional storage bags 304,304′ through tubing 306. Using tube 308,308′, blood products can even be moved through one or more filter 310 and into a filtered storage bag 312. In one example, the filter is a leukocyte blood filter and leukocyte free red blood cells are stored in filtered storage bag 312.

In the general process of moving blood products between bags, the entire bag system 300 must be centrifuged in order to separate different blood components. As such, bag system 300 must be placed within internal volume 216 of centrifuge bucket 200.

Bag system 300 can encase any liquid or semisolid, hazardous or not. Bag system can have numerous bags interconnected or not, even having small amounts of material inside (e.g. less than about 100 mL). Exemplary non-limiting liquids and semisolids are blood, urine, contaminated water, water for constituent testing, oil, gasoline, pharmaceutical drugs, beverages, soft stool samples, saliva, bile, semen, sweat, other bodily fluids, and the like. Other substances not mentioned which need to be centrifuged at low speed can be adapted for use with the present retention systems.

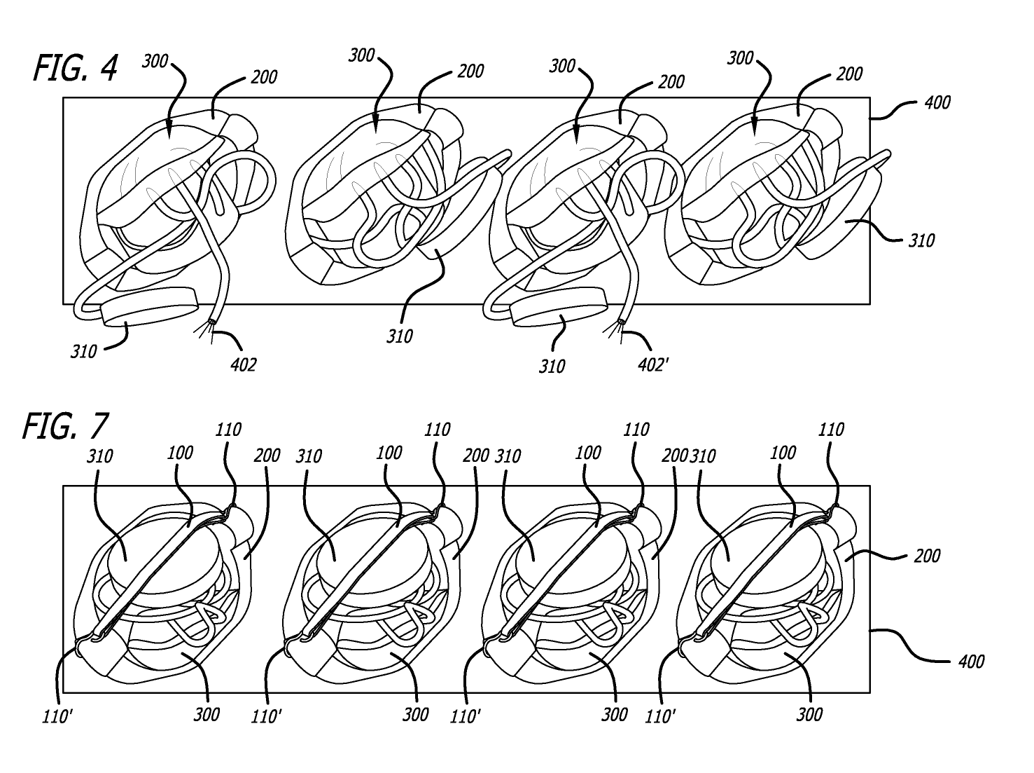

Previous to the development of the retention systems described herein, bag system 300 was placed within internal volume 216 of centrifuge bucket 200, loaded into the rotor of a low speed centrifuge machine, and spun at an appropriate speed depending on the desired separation. The results are illustrated in FIG. 4. As can be seen in FIG. 4, buckets 200 are unloaded from a centrifuge rotor and placed in block 400 until further processing is needed. Typically, six buckets can be accommodated by block 400 (generally the same number of buckets as rotor positions, here for simplicity, only four are illustrated). In many cases, components of bag system 300, particularly filter 310 became dislodged from centrifuge bucket 200. In some cases, blood components from bag system 300 become displaced 402, 402′ and contaminate the entire centrifuge machine and its integral components.

As one skilled in the art will appreciate, displaced hazardous material that may be highly contaminated (e.g. blood infected with HIV/AIDS, hepatitis, and the like) can be extremely costly to clean and sterilize. Even the spilling, rupturing or displacement of non-hazardous materials requires time to clean, although sanitization might not be required. Further, as a result of the high cost of the centrifuge machines themselves, frequently a separation facility might only have one machine or may be processing so many bag systems at a time that a single centrifuge system being down can be catastrophic.

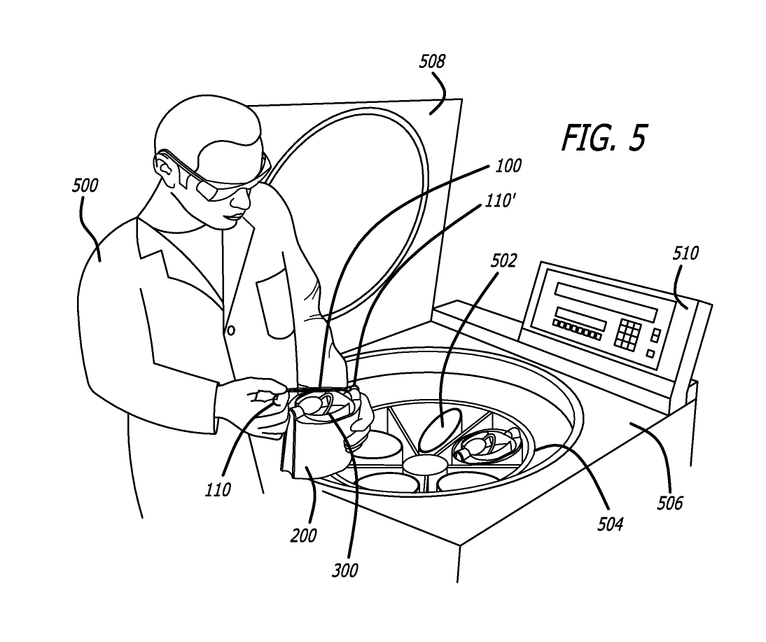

As such, in one example embodiment, as illustrated in FIG. 5, elastic member 100 including first securing member 106 and second securing member 108 with hooks 110, 110′ is used to retain bag system 300 within centrifuge bucket 200. Operator 500 first attaches hook 110′ to first grasping means 206. Then, elastic member 100 is stretched across bag system 300 including filter 310, and hook 110 is attached to second grasping means 208. At this point, the retained system can be placed in slot 502, for example, of rotor 504 within centrifuge 506. Then, operator 500 finishes loading samples into rotor 504, closes lid 508 and starts centrifuging using control panel 510.

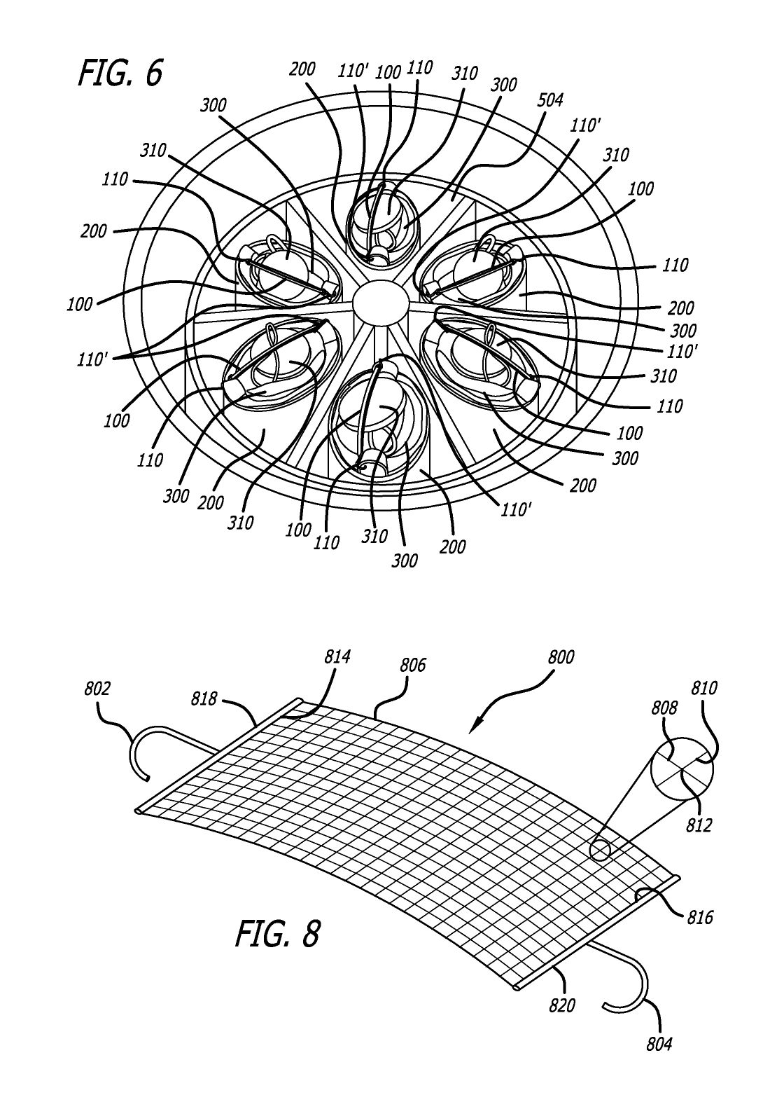

After a centrifuge process is completed, each centrifuge bucket is removed from rotor 504. As is illustrated in FIG. 6, rotor 504 contains six centrifuge buckets 200, with bag system 300 including filter 310. Because elastic member 100 is hooked to centrifuge bucket 200 using hooks 110, 110′, none of the items loaded into centrifuge buckets 200 become dislodged and as a result there is little potential for contamination of the centrifuge system.

At this point, each centrifuge bucket including the intact items, can be transferred one by one back to block 400 as illustrated in FIG. 7. One advantage to the present retention systems is that even if items, such as bag system 300, do not become dislodged during the centrifugation process, filter 310 and even tubes dangling out of centrifuge bucket 200 can be a hazard. For example, a tube dangling out of centrifuge bucket 200 can get caught on any number of items in a laboratory bench area. Such an action can tear locations within bag system 300 causing hazardous material to become displaced in the laboratory, again requiring a time consuming and expensive clean up.

Once loaded into block 400, the set of six centrifuge buckets 200 including bag system 300 retain therein can be safely transported to the next appropriate location for storage or further processing. The retention system can remain on a centrifuge bucket as long as needed.

Now that a process has been disclosed wherein retention systems are useful, further properties of the system can be described. For example, in one embodiment, the retention systems described herein can be disposable or can be reusable. If disposable, the retention systems can be made of relatively inexpensive materials that can be discarded once used. However, despite the inexpensive nature of the components used for the retention systems in such embodiments, the components must still have sufficient strength to withstand the forces involved in a centrifugation system without failing.

In a reusable embodiment, the retention system can be formed of materials that can be subjected to sterilization techniques such as, but not limited to steam sterilization, gamma irradiation, autoclave, and the like. Further, the elastic member and the at least one securing member can be made of a material that can withstand such techniques or can be coated with an appropriate polymer that can.

For example, if elastic member is made of latex rubber, such a material can become dried out and brittle especially if subjected to a technique such as an autoclave. As such, the rubber can be coated with an inert flexible polymer such as silicone, polyurethane, or the like.

Further, when sterilization techniques can degrade the securing members depending on their formation materials, materials that can withstand the techniques are used. For example, aluminum or zinc might rust and/or corrode if autoclaved. As such, materials such as stainless steel, titanium, gold, platinum or the like can be used. Alternatively or in addition, the at least one securing member can be coated with a polymer or other appropriate material (e.g. metal) that will resist rust and corrosion. Teflon, gold, chrome, or the like can be appropriate coating materials.

Whether coating the elastic member or the at least one securing member, the coating may be applied by dipping, brushing, spraying, chemical vapor deposition or the like. Electric plating is also an option for coating.

In addition to an elastic member and two securing members as illustrated in FIGS. 1A and 1B, other configurations are within the scope of the present disclosure. For example, as illustrated in FIG. 8, retention system 800 includes first securing member 802, second securing member 804. First securing member 802 and second securing member 804 can be formed of any material described in the present disclosure. In one example, embodiment, first securing member 802 and second securing member 804 are formed of plastic. Elastic member 806 is in a net configuration with both transverse elements 808 and lateral elements 810 that intersect perpendicularly at each intersection point 812. Elastic member 806 is connected at first end 814 and second end 816 to first securing member 802 and second securing member 804 using first flexible termination member 818 and second flexible termination member 820. First flexible termination member 818 and second flexible termination member 820 are made of flexible materials that can be flexed and returned to their original position many times without breaking. In some embodiments, the flexible termination members can be flexed about 5 times, about 25 times, about 50 times, about 100 times, about 500 times, about 1,000 times, about 10,000 times or more. Flexible metals or plastics can be used. Further, a flexible metal covered with a flexible plastic can aid in structural support over time.

To use retention system 800, first securing member 802 and second securing member 804 are attached to centrifuge bucket 200 at first grasping means 206 and second grasping means 208. At this point, elastic member 806 and first flexible termination member 818 and second flexible termination member 820 will assume a straight position at the apex of the items within centrifuge bucket 200. Then, first flexible termination member 818 and second flexible termination member 820 are physically bent downward over the items thereby contouring to their overall shape. As a result of the nature of first flexible termination member 818 and second flexible termination member 820 they can be reused and bent to match each particular bucket's item configuration. Using such a configuration allows for nearly total restraint.

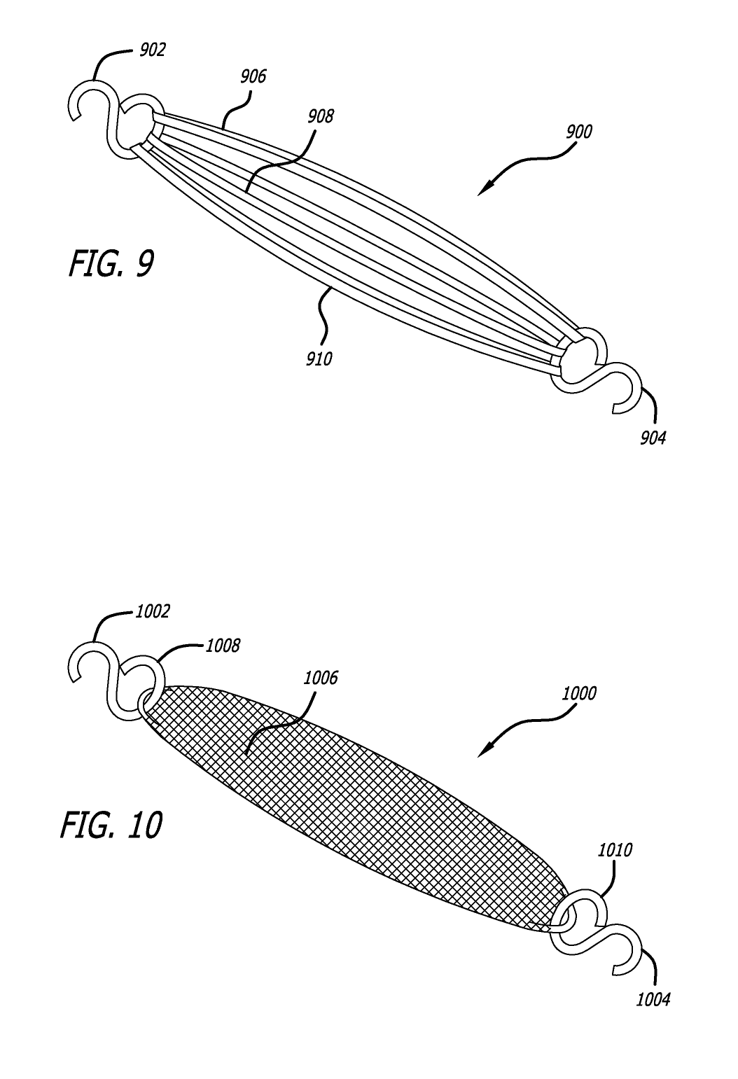

In another embodiment, illustrated in FIG. 9, is retention system 900 including first securing member 902 and second securing member 904. First securing member 902 and second securing member 904 can be formed of any material described in the present disclosure. In one example, embodiment, first securing member 902 and second securing member 904 are formed of aluminum. In this particular embodiment, first elastic member 906, second elastic member 908 and third elastic member 910 are illustrated. However, two elastic members or three or more elastic members are also contemplated herein.

Once secured on centrifuge bucket 200 at first grasping means 206 and second grasping means 208 using first securing member 902 and second securing member 904, first elastic member 906, second elastic member 908 and third elastic member 910 can be spread apart over the items inside centrifuge bucket 200. Such an embodiment allows retention coverage of a greater area then a single elastic member.

In yet another embodiment, illustrated in FIG. 10, is retention system 1000 including first securing member 1002 and second securing member 1004. First securing member 1002 and second securing member 1004 can be formed of any material described in the present disclosure. In one example embodiment, first securing member 1002 and second securing member 1004 are formed of aluminum. In this particular embodiment, elastic member mesh system 1006 is used to retain the items within centrifuge bucket 200. Elastic member mesh system 1006 converges and secures to first securing member 1002 and second securing member 1004 at first loop 1008 and second loop 1010. Once placed on centrifuge bucket 200, retention system can be spread over the bucket's items much like a net over a pallet of items to secure items contents.

Regardless of the configuration of items within a centrifuge bucket, the items need to remain restrained therein during transportation and centrifugation. The retention systems described herein accomplish this task and prevent unwanted system wide contamination by release of material from unrestrained items.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents and printed publications throughout this specification. Each of the above-cited references and printed publications are individually incorporated herein by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

I claim:

1. A retention system comprising:
at least one elastic member coupled to at least one securing member;
a centrifuge bucket; and
at least one item in said centrifuge bucket;
wherein said elastic member is attachable to at least two points on said centrifuge bucket thereby retaining said at least one item within said centrifuge bucket.

2. The retention system according to claim 1 wherein said at least one securing member is a hook.

3. The retention system according to claim 2 having two hooks.

4. The retention system according to claim 1 wherein said elastic member is about 0.5 inches wide in a relaxed state.

5. The retention system according to claim 1 wherein said elastic member is about 3.5 inches long in a relaxed state.

6. The retention system according to claim 1 wherein said centrifuge bucket comprises a lip having two convex protrusions on opposite sides of said lip.

7. The retention system according to claim 1 wherein said at least two points are said two convex protrusions.

8. The retention system according to claim 7 wherein said at least two points further include two additional points on said lip.

9. The retention system according to claim 1 wherein said at least one item is at least one blood bag.

10. The retention system according to claim 9 further comprising a blood filter.

11. The retention system according to claim 1 for use in a centrifuge instrument at a speed sufficient to separate blood components.

12. The retention system according to claim 11 wherein said retention system prevents said at least one item from dislodging from said centrifuge bucket during a centrifugation.

13. A method of preventing contamination in a centrifuge system comprising:
providing a centrifuge bucket and at least one item to be placed within the centrifuge bucket for centrifugation;
placing the at least one item within the centrifuge bucket;
retaining said at least one item within the centrifuge bucket using at least one elastic member coupled to at least one securing member;
centrifuging the at least one item within the centrifuge bucket;
prohibiting rupture or dislocation of at least one item; and
preventing contamination in a centrifuge system.

14. The method according to claim 13 wherein the at least one securing member is a hook.

15. The method according to claim 14 having two hooks.

16. The method according to claim 13 wherein said elastic member is rubber.

17. The method according to claim 13 wherein said at least one item is at least one blood bag.

18. The method according to claim 17 further comprising a blood filter.

19. A retention system comprising:
an elastic member about 0.5 inches wide and about 3.5 inches long in a relaxed state coupled to two hooks;
a centrifuge bucket comprising a lip having two convex protrusions on opposite sides of said lip; and
at least one blood storage component in said centrifuge bucket;
wherein said elastic member is attachable to said two convex protrusions on said centrifuge bucket thereby retaining said at least one blood storage component within said centrifuge bucket.

20. A method of preventing contamination of a centrifuge system by hazardous material comprising:
providing a centrifuge bucket and a blood bag system including a filter to be placed within the centrifuge bucket for centrifugation;
placing the blood bag system including a filter within the centrifuge bucket;
retaining the blood bag system including a filter within the centrifuge bucket using an elastic member coupled to at least two hooks coupled to the lid of the centrifuge bucket;
centrifuging blood contained within the blood bag system;
prohibiting rupture or dislocation of the blood from the blood bag system; and
preventing contamination of the centrifuge system by hazardous material.
